(19) United States
(12) Patent Application Publication
(10) Pub. No.: US 2017/0051367 A1
(43) Pub. Date: Feb. 23, 2017

(54) PELT BOARD

(71) Applicant: Eikon Technologies Holding S.à.r.l., Luxembourg (LU)

(72) Inventor: Kurt Pedersen, Vinderup (DK)

(21) Appl. No.: 15/238,627

(22) Filed: Aug. 16, 2016

(30) Foreign Application Priority Data
Aug. 17, 2015 (DK) PA201570533

(51) Int. Cl. C14B 15/06

(52) U.S. Cl. CPC C14B 15/06

(57) ABSTRACT

A pelt board for drying of tubular pelts has a tip end from which the pelt is drawn onto the pelt board and a foot end. The pelt board includes two broad side surfaces, each extending in the longitudinal direction of the pelt board. One of the broad side surfaces is of a substantially linear cross-sectional outer contour at least in a holding area of the pelt board. The other of the broad side surfaces is of a substantially convex cross-sectional outer contour. The holding area is positioned in the half part of the pelt board nearest the foot end thereof and extends at least 25 cm, preferably at least 30 cm in the longitudinal direction of the pelt board.

### CROSS-REFERENCE TO RELATED APPLICATION

This application claims priority to Danish Patent Application No. PA201570533 filed on Aug. 17, 2015, the disclosure of which including the specification, the drawings, and the claims is hereby incorporated by reference in its entirety.

### FIELD OF THE INVENTION

The present invention relates to a pelt board for stretching and drying of tubular pelts from fur animals, in particular from mink such as pelts of male mink and the use thereof.

### BACKGROUND

Frames on which pelts can be stretched and dried after pelting of the fur animals are well known in the art, ranging from a simple flat and solid wooden slat to more sophisticated pelt boards (or pelting boards) in wood or plastic material.

The overall shape of the known pelt boards are generally of a tapering or conical shape, pelt boards for male animal pelts are often provided with a short part of a constant cross-sectional circumference at the foot end of the pelt board where the tail end of the pelt is supposed to be arranged.

U.S. Pat. No. 3,313,038 discloses a pelt drying frame in plastic or non-absorbent material and wood which as an open internal structure that allows for drying air to be supplied to the cavity defined by the frame and the tubular pelt in order to enhance the drying of the pelt. The frame also contains an arrangement for stretching of the tubular pelt in the longitudinal direction thereof.

Another pelting board is disclosed in WO 82/03634, which is manufactured in a non-absorbent plastic and comprises a lattice of girders between the edges of the pelting board for improving the airflow of drying air inside the pelting board.

A problem for the aforementioned types of pelt boards is that the tubular pelt shrinks during the drying process and will exert a squeezing force on the pelt board. Thus, the dried pelt may be difficult to remove from the pelt board and in a few case it is necessary to cut the pelt open to be able to remove it from the pelt board.

An alternative arrangement for drying of tubular pelts is disclosed in U.S. Pat. No. 3,137,963 and in U.S. Pat. No. 3,271,981 comprises a frame with two legs that are pivotally connected at one end, which is inserted into the tubular pelt to be dried, and a lever at the opposite end which is used to force the two legs from each other and ensure that the pelt is taut on the frame when drying. When the pelt is sufficiently dry, the lever is turned and the legs are allowed to pivot and collapse the frame for easy removal of the dried pelt. The pelt is during the drying only supported by the two legs for promoting the circulation of air on the inside of the pelt. However, it is today preferred to dry the pelts on an actual pelt board that support the inner surface of the tubular pelt during the drying process.

The pelt board disclosed in WO 2005/026394 has a general tapering shape towards a tip end of the pelt board from which the pelt is to be arranged on and removed from the pelt board after drying, so as to facilitate the removal of the dried pelt.

Furthermore, in order to facilitate a more efficient removal of the dried pelt from the pelt board is comprises two half parts that are forced from each other and locked in a position, where the circumference is larger and slot-shaped openings are formed between the edges of the half parts and where the pelt is drawn upon the pelt board for drying thereof, and the pelt board may when the pelt is dried be shifted to a second position where the edges of the two half parts abut and the circumference consequently is smaller and the pelt may be removed more easily. The two half parts are identical and are provided with arched surfaces in order to provide a greater friction between the pelt and the broad sides of the board, so that a fixing bag that is drawn over the pelt when stretched on the board will be more efficient in fastening the pelt to the board. The holding area of the board on which the fixing bag presses the pelt towards the board is provided with a transverse grooving or serration to further improve the fastening of the pelt to the board.

Another pelt board is disclosed in WO 2014/032950 having two identical curved broad side elements and two narrow side elements that can be moved in and out between the edges of the broad side elements so as to change the cross-sectional circumference of the pelt board, whereby a pelt fastened and dried on the pelt board is loosened and is easily removed.

The object of the present invention is to provide a further improved pelt board.

### BRIEF DESCRIPTION OF THE INVENTION

The present invention relates to a pelt board for drying of tubular pelts, which preferably also are stretched on the pelt board, the pelt board having a tip end from which the pelt is drawn onto the pelt board and a foot end, the pelt board comprising two broad side surfaces each extending in the longitudinal direction of the pelt board, wherein at least in a holding area of the pelt board, one of the broad side surfaces is of a substantially linear cross-sectional outer contour, whereas the other of the broad side surfaces is of a substantially convex cross-sectional outer contour, and wherein said holding area is positioned in the half part of the pelt board nearest the foot end thereof and extends at least 25 cm, preferably at least 30 cm in the longitudinal direction of the pelt board.

The back side and the belly side of a pelt are of different characteristics as the skin on the back side of the animal is thicker and stronger than the skin on the belly side, and the skin on the back side will contract with a larger force when drying. In case the tail of a pelt is not fastened sufficiently to the pelt board with the external fixing means pressing the pelt to the pelt board, this may cause an m-shape of the lower edge of the pelt as the middle of the back side of the pelt becomes shorter than the

With the pelt board according to the present invention, the symmetric broad side surfaces of the well-known pelt boards have been replaced with asymmetric sides in at least the holding area, which is intended to be the position at which the external fixing means, such as a fixing bag known from e.g. WO 01/62985 or an elastic band as disclosed in e.g. EP 1 723 262 B1. The broad side surfaces comprises one that has a convex outer contour for supporting the back side of the pelt and a flat broad side surface with a linear cross-sectional outer contour for supporting the belly side of the pelt. Hereby, the largest pressure force from the fixing means will be applied to the back side of the pelt which is the one requiring the largest holding force when the pelt is drying. It is thus achieved that a sufficient fixing pressure can be applied to the back side of the pelt without increasing the pressure force from the fixing means on the belly side which prevents pressure damages to the thinner belly side skin.

The tip end of the pelt board is suitable for engaging with the end of the pelt that covered the cranium of the animal and is normally of the smallest circumference of the pelt board. The preferred mink pelt board according to the present invention comprises a tapering part including the tip end, which is about 90 centimetres long, and a lower part including the foot end of the pelt board of substantially constant cross-sectional circumference, the length of which is adapted to the particular type and gender of the animal providing the pelt. Likewise is the circumferential size of the lower part determined by the type and gender.

With the term cross-sectional outer contour is understood the outer contour presented by the broad side surfaces in a cross-section of the pelt board along the line of an elastic member encircling the pelt board, in particular the inner side of a tubular pelt that is stretched onto the pelt board. The circumference of the pelt board is defined in the same manner, i.e. as the length of an elastic member encircling the pelt board. In case the pelt board is of the expanding type, the circumference is determined in the expanded state unless otherwise is specified.

The substantially convex outer contour may comprise one single curve e.g. an arc of a circle, or it may be formed a polygon outer contour comprising a plurality of straight or curved parts between the two side edges of the broad side surface.

The holding area is not necessarily of a well-defined longitudinal extend and the properties defined for the holding area, such as the cross-sectional outer contours of the two broad side surfaces being linear and convex, respectively, may also apply beyond the extend of the holding area, such as throughout the whole of the pelt board's longitudinal extend.

The broad side surface of substantially linear cross-sectional outer contour constitutes in a preferred embodiment at least 20%, preferably at least 25% of the cross-sectional circumference of the pelt board at the holding area. This means, that the width of the linear or flat side of the pelt board constitutes at least 20%, such as at least 25% of the full circumference of the pelt board at the holding area. A practical upper limit of the width of the substantially linear cross-sectional outer contour is about 40% of the cross-sectional circumference.

The two broad side surfaces constitute preferably at least 65%, more preferably at least 75% of the cross-sectional circumference of the pelt board at the holding area.

The height of the vertex of the convex cross-sectional outer contour is preferably in the range of 8 to 25 millimetres from the baseline of the convex outer contour of the broad side surface, preferably in the range of 10 to 20 millimetres.

The pelt board preferably comprises two half parts each defining one of said broad side surfaces.

The broad side surfaces within the holding area are preferably provided with a plurality of protrusions so as to provide a roughness of the surfaces, such as corrugations, grooves, spikes or ridges, in order to enhance the ability of fixing means, such as a wrapping or a fixing bag, applied at the outer surface of the pelt arranged on the pelt board, to secure the pelt in the stretched position on the pelt board. Such protrusions may also be provided outside of the actual holding area, i.e. where the cross-sectional outer contours of the two broad side surfaces are linear and convex, respectively.

The height of said protrusions is preferably in the range of 0.75 to 5 millimetres, more preferably in the range of 1 to 3 millimetres.

According to a first embodiment of the present invention, the pelt board is designed to be used for mink pelts of male minks according to a US standard, for which reason the cross-sectional circumference of the pelt board at the holding area is in the range of 220 to 240 millimetres.

According to a second embodiment of the present invention, the pelt board is designed for mink pelts of male mink according to a European standard, for which reason the cross-sectional circumference of the pelt board at the holding area is in the range of 242 to 260 millimetres.

For pelt boards according to the first or the second embodiment, the length of the pelt board from the tip end to the foot end thereof is preferably in the range of 120 to 160 centimetres, more preferably in the range of 125 to 155 centimetres.

According to a third embodiment of the present invention, the pelt board is designed for use for mink pelts of female mink, for which reason the cross-sectional circumference of the pelt board at the holding area is in the range of 180 to 200 millimetres.

For pelt boards according to the third embodiment, the length of the pelt board from the tip end to the foot end thereof is preferably in the range of 100 to 130 centimetres, more preferably in the range of 105 to 120 centimetres.

According to a fourth embodiment of the present invention, the pelt board is designed for use for fox pelts, for which reason the cross-sectional circumference of the pelt board at the holding area is in the range of 380 to 400 millimetres.

For pelt boards according to the fourth embodiment, the length of the pelt board from the tip end to the foot end thereof is preferably in the range of 170 to 200 centimetres.

It is further preferred that the pelt board according to the present invention is comprising expansion means for selectively shifting the pelt board between an expanded position and a non-expanded position in which the outer cross-sectional circumference of the pelt board is reduced as compared to the expanded position. In particular, it is preferred that the outer cross-sectional circumference of the pelt board is reduced in the range of 3 to 20 millimetres at least in the holding area when the expansion means are in the non-expanded position of the expansion means, preferably in the range of 5 to 15 millimetres.

It is also preferred that the pelt board according to the present invention comprises an element projecting from the foot end of the pelt board, the projecting element having an inlet for receiving a flow of air and an air conducting arrangement including openings in an outer surface of the pelt board connected to said inlet for providing a flow of air to a pelt arranged on the pelt board.

It is furthermore preferred that the expansion means may be operated by means of displacing the projecting element in the longitudinal direction of the pelt board.

The present invention furthermore relates to the use of a pelt board as described herein for drying of tubular pelts, wherein the back side of the pelt is arranged at the broad side surface of convex outer contour, and the belly side of the pelt is arranged at the broad side surface of the linear outer contour.

The pelt is preferably stretched in a longitudinal direction of the pelt board towards the foot end of the pelt board and fixing means are applied to the fur side of the pelt at a position of the holding area so as to fix the pelt to the pelt board.

Said pelts are preferably mink pelts, in particular male mink pelts.

### BRIEF DESCRIPTION OF THE FIGURES

Aspects of the present disclosure will be described in the following with reference to the Figures in which:

FIG. 1 is a front view of a pelt board for drying tubular furs such as mink furs, according to embodiments of the invention including a detail of the tapering end of the pelt board,

FIG. 2 is a cross-section of the pelt board at the holding area,

FIGS. 2a and 2b shows the cross-sections of FIG. 2 with indications of various parameters,

FIG. 3 illustrates a cross sectional view in perspective of the pelt board,

FIG. 4 illustrates an embodiment of an distension system of a pelt board according to embodiments of the invention,

FIG. 5 is a cross-section of a pelt board with the distension system of FIG. 4,

FIGS. 6a and 6b are cross-sections of a pelt board with the distension system of FIGS. 4 and 5 in an expanded and a non-expanded position,

FIGS. 7 and 8 are longitudinal sectional views of a tapered end part of a pelt board according to embodiments of the invention,

FIG. 9 illustrates a pelt board according to embodiments of the invention seen from the tapered end of the pelt board,

FIG. 10 Fig. illustrates a further embodiment of a pelt board seen from the foot end according to embodiments of the invention, and

FIGS. 11a and 11b illustrate a drying system according to embodiments of the invention.

### DETAILED DESCRIPTION OF THE INVENTION

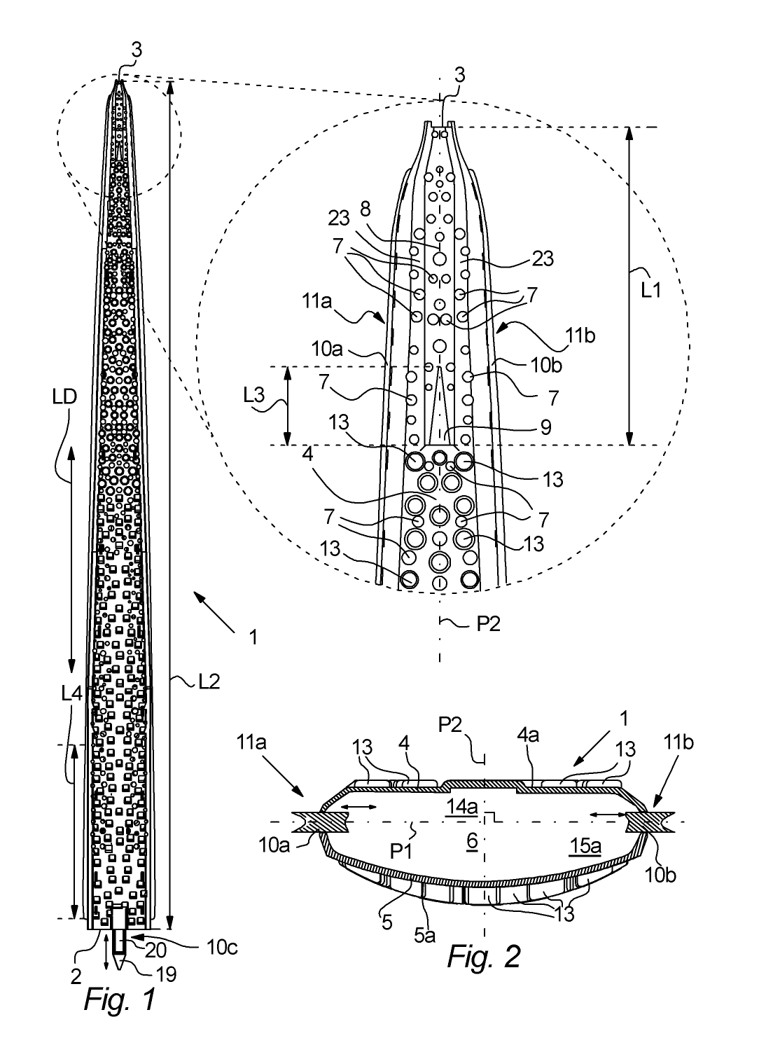

FIG. 1 illustrates a pelt board 1 for drying tubular furs such as mink furs, according to embodiments of the invention. The pelt board has a foot end 2 and a tapered end 3, which may also be referred to as a tip end. The foot end 2 is wider and has a larger circumference than the tip end/tapered end 3.

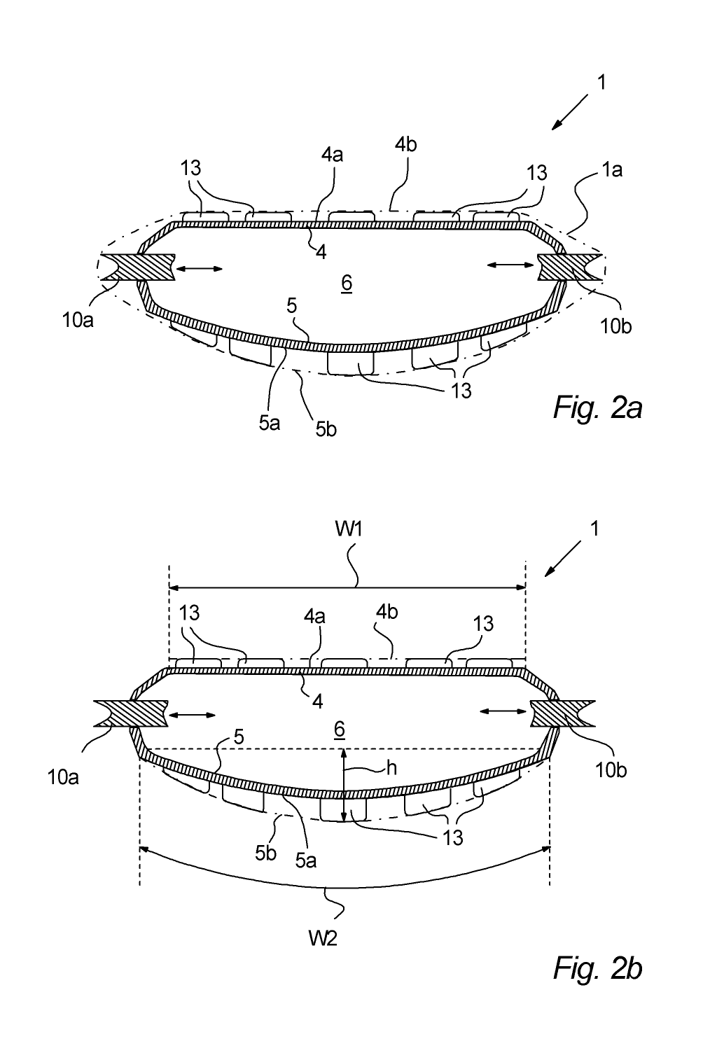

The pelt board 1 comprises two half parts 4, 5 (half part 4 is illustrated in FIG. 1, see also FIG. 2 illustrating a cross sectional view of the pelt board 1 seen from the foot end 2). The half parts 4, 5 each comprises a plurality of protrusions 13 at the exterior surfaces, and the half parts 4, 5 extend between opposite longitudinal side edges 11a, 11b of the pelt board 1. The protrusions 13 may comprise circular protrusions (illustrated in FIG. 1 by two rings, one inside the other) and/or rectangular protrusions or any combination thereof. The circular protrusions 13 may in embodiments of the invention have a substantially frustoconical shape.

The longitudinal extend L4 of the holding area is indicated on FIG. 1 and starts typically at or just above the foot end 2 of the pelt board 1. It extends at least 25 to 30 centimetres towards the tip end 3, typically about 40 to 50 centimetres in pelt boards 1 in which the holding area is a delimited area, so as to provide sufficient space to fix pelts of different lengths to the pelt board by pressing the pelt towards the holding area by means of fixing means as discussed previously.

A cross-section of the pelt board 1 at the holding area is shown in FIG. 2a, where for clarity only the protrusions 13 closest to the position of the cross-section are depicted. The cross-sectional outer contour of the pelt board 1 at the holding area is illustrated with a dotted line 1a which is the contact line of an elastic member encircling the pelt board 1, such as the inner side of a tubular pelt 30 that is stretched onto the pelt board 1. Thus, the length of the cross-sectional outer contour la determined in this manner is the cross-sectional circumference of the pelt board 1 at the position of the cross-section. The cross-sectional circumference is determined when the pelt board is expanded, i.e. when the expansion means are in the expanded position. In FIG. 2a, the longitudinal part of the distension system 10a, 10b are consequently shown in their outermost or expanded position.

The half parts 4, 5 provides an internal cavity 6 for distributing drying air internally in the pelt board 1 between the half parts 4, 5, see FIG. 2. It is noted that internal parts of the pelt board 1 in the cavity 6, in the form of elements of the distension system of the pelt board 1, connection parts for interconnecting the half parts 4, 5 and/or the like has been omitted in FIG. 2 in order to enhance the understanding and simplicity of the drawing.

The half parts 4, 5 are in preferred embodiments of the invention substantially symmetric around at least the second centre plane P2, but the half parts 4, 5 are not symmetric around the first centre plane P1 of the pelt board 1.

One of the half parts 4 has as shown in FIG. 2b a substantially flat profile 4a of a width W1 corresponding to about one third of the total circumference of the pelt board 1 at the position of the cross-section, which is at the holding area. The other half part 5 has a substantially convex profile 5a and preferably provide as a half shell. The width W2 of the convex profile 5a corresponds to about 50% of the total circumference of the pelt board 1 at the position of the cross-section, which is at the holding area. The height h of the vertex of the convex profile 5a is found as the distance between the vertex and the base line of the convex profile as shown in FIG. 2b.

In preferred embodiments of the invention, both half parts 4, 5 as illustrated in FIG. 2 each comprises a hollow 14a, 15a which together provides the internal cavity 6 between the half shells 4, 5.

A plurality of ventilation openings 7 for providing a flow of drying air between the internal cavity 6 and the outer surface of the half parts 4, 5 are provided in the half parts 4, 5, see FIG. 1. These ventilation openings 7 are arranged in the surface of the respective half part 4, 5 between the protrusions 13. Hereby drying air can be provided from the internal cavity 6 to the exterior of the pelt board between a tubular fur arranged on the pelt board 1 with the skin side facing the pelt board, and the pelt board surface 4a, 5a so as to dry the tubular fur. Hence, when a tubular fur is arranged at the pelt board 1, the skin side will support on the protrusions 13, and thus a cavity is formed between the outer surface 4a, 5a of the half part and the skin side of the tubular fur along the outer contour 4b, 5b of the outer surfaces 4a, 5a. Alternatively, an inner bag made of a moisture absorbing material, such as paper, is provided between the pelt board 1 and the tubular pelt in order to absorb moisture from the pelt and submit it to the flow of air in the space created by the protrusions 13. Air can thus be provided into this cavity between the outer surface 4a, 5a of the respective half part 4, 5 and the skin side of the tubular fur from the internal cavity 6 of the pelt board, through the ventilation openings 7 and hereby dry the skin.

The pelt board 1 moreover comprises a distension system configured to reduce or increase the circumference of the pelt board dependent on the setting of the distension system. In the present example, the distension system comprises two longitudinal parts 10a, 10b extending along the longitudinal edges 11a, 11b of the pelt board.

As illustrated in FIG. 2, the longitudinal edges 11a, 11b define a first plane P1 extending through the longitudinal edges 11a, 11b of the pelt board 1. A second centre plane P2 is substantially perpendicular to the first plane P1, and both planes P1, P2 extends in the longitudinal direction LD of the pelt board 1.

The longitudinal parts 10a, 10b can be operated in order to increase the overall circumference of the pelt board, in the present example by moving the longitudinal parts towards or and away from the second plane P2. When the longitudinal parts 10a, 10b have been arranged in an expanded position (as illustrated in FIG. 2), they are moved away from the second plane P2. When the longitudinal parts 10a, 10b have been arranged in a collapsed position they are moved towards the second plane P2. In the collapsed position, the overall circumference of the pelt board 1 is smaller than when the longitudinal parts 10a, 10b are arranged in the expanded position. The half parts 4, 5 are preferably thus kept in a fixed position and the expansion and collapsing of the pelt board may alone be provided by controlling the longitudinal parts 10a, 10b at the longitudinal edges 11a, 11b of the pelt board 1.

The moving of the longitudinal parts 10a, 10b at the longitudinal edges 11a, 11b of the pelt board 1 is preferably provided by moving the longitudinal parts 10a, 10b in the first plane P1.

In other embodiments of the invention (not illustrated), the distension system of the pelt board may be arranged to move the half parts 4, 5 towards and away from each other, e.g. as disclosed in WO 2005/026394 A1 so as to alter the circumference of the pelt board 1.

As illustrated in FIG. 1, one of the half parts 4, 5 comprises an outer guiding recess 8 for receiving an air exchange part that can exchange air in the internal cavity 6.

The guiding recess 8 extends substantially from the tapered end/tip end 3 of the pelt board 1 in a direction towards the foot end 2. The guiding recess 8 ends substantially at a drying air supply opening 9 to the internal cavity 6. The guiding recess 8 is arranged so that a pipe or the like can extend in between a pelt on the pelt board 1 (described in more details later on) from the tapered end, and thus provide drying air into, or extract drying air from, the internal cavity 6 through the drying air supply opening 9.

In preferred embodiments of the invention, the drying air supply opening 9 extends in a substantially transverse direction compared to the longitudinal axis of the pelt board.

In advantageous embodiments of the invention, the length L1 of the guiding recess 8 is no more than ⅕ of the length L2 of the pelt board 1 such as no more than 1/10 of the length of the pelt board, e.g. no more than 1/15 of the length of the pelt board, e.g. about 1/20 of the length of the pelt board.

In advantageous embodiments of the present invention, the drying air supply opening 9 at the tapered end part 3 is oblong and extends in the longitudinal direction LD of said pelt board 1. In the present example, the longitudinal has a wedge shape and tapers towards the tip end of the pelt board. However, it may also be rectangular or oval-shaped. The length L3 of the opening 9 may be between 1.5 cm and 20 cm such as between 2 cm and 10 cm, e.g. between 2.5 and 6 cm. The width off the opening may be between 0.5 and 5 cm such as between 0.5 and 3 cm, e.g. about 1 cm or 2 cm.

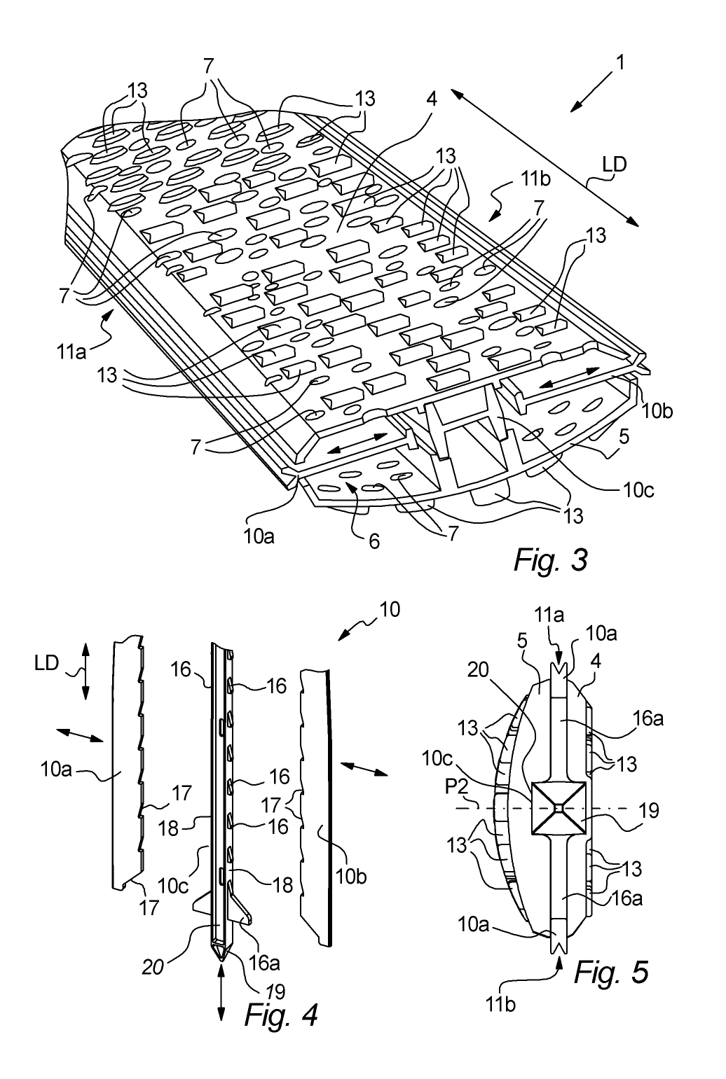

FIG. 3 illustrates a cross sectional view of the pelt board 1 seen in perspective according to embodiments of the invention, where an embodiment of the distension system is illustrated in more details.

The distension system comprises the longitudinal parts 10a, 10b which are configured to be operated in order to increase or decrease the overall circumference of the pelt board 1. Moreover, the distension system comprises a longitudinal member 10c in the internal cavity 6 between the half parts 4, 5, extending in the longitudinal direction LD of the pelt board 1. The longitudinal member 10c is arranged between the longitudinal parts 10a, 10b, and when the longitudinal member 10c is displaced in the longitudinal direction LD of the pelt board 1, the longitudinal parts 10a, 10b are is displaced relative to the half parts 4, 5 in a direction away or towards the second plane P2, see FIG. 2.

This may be provided by the longitudinal member 10c comprising a plurality of wedge-shaped elements 16 configured to fit into recesses 17 in the longitudinal parts 10a, 10b as described in more details in connection to FIG. 4.

As can be seen from FIG. 3, the pelt board comprises a plurality of protrusions 13 at the outer surface of the half parts 4, 5, and a plurality of ventilation openings 7 provided between the protrusions in order to enable a flow of drying air between the exterior of the pelt board and the internal cavity 6.

FIG. 4 illustrates an embodiment of the distension system according to embodiments of the invention, seen in perspective. The longitudinal member 10c comprises a plurality of wedge-shaped elements 16, 16a arranged at opposing surfaces 18. The wedge-shaped elements 16 are configured to fit into recesses 17 in the longitudinal parts 10a, 10b when the distension system 10a, 10b, 10c is arranged in a collapsed state. When displacing the longitudinal member 10c in a direction towards the tip end 3, relative to the half parts 4, 5, the wedge shaped elements 16, 16a forces the longitudinal parts 10a, 10b away from the longitudinal member 10c to an expanded position, thereby increasing the circumference of the pelt board 1 as the longitudinal parts 10a, 10b extends further out between the half parts 4a, 5a than when in a collapsed position.

The longitudinal member 10c comprises a lower part 19 extending in the longitudinal direction LD of the pelt board from the foot end 2 of the pelt board. This part provides a part that can be operated in order to provide the displacement of the longitudinal member 10c.

The longitudinal member 10c may in embodiments of the invention comprises a lowest wedge shaped element 16a near the lower part 19. This element 16a is configured to block the foot end 2 of the pelt board 1 so that air is substantially only supplied at the channel 20 and thus e.g. guided more efficiently inside the pelt board in the cavity 6.

Moreover, the longitudinal member 10c may on embodiments of the invention comprise a channel 20 for guiding drying air from a drying aggregate at the foot end 2 to the internal cavity 6 in the pelt board 1. The drying aggregate (not illustrated) may comprise a top plate with openings for receiving the lower part 19 and be configured to provide drying air to the cavity 6 at the foot end 2 of the pelt board 1 when the pelt board 1 is arranged vertically in the drying aggregate 1. The drying aggregate may comprise a blowing unit for providing an air flow through the said top plate.

FIG. 5 illustrates an embodiment of the pelt board 1 seen from the foot end 2. The pelt board 1 is in FIG. 5 illustrated in an expanded position, and the longitudinal parts 10a, 10b are displaced away from the centre plane P2 to an outer position to increase the circumference of the pelt board 1.

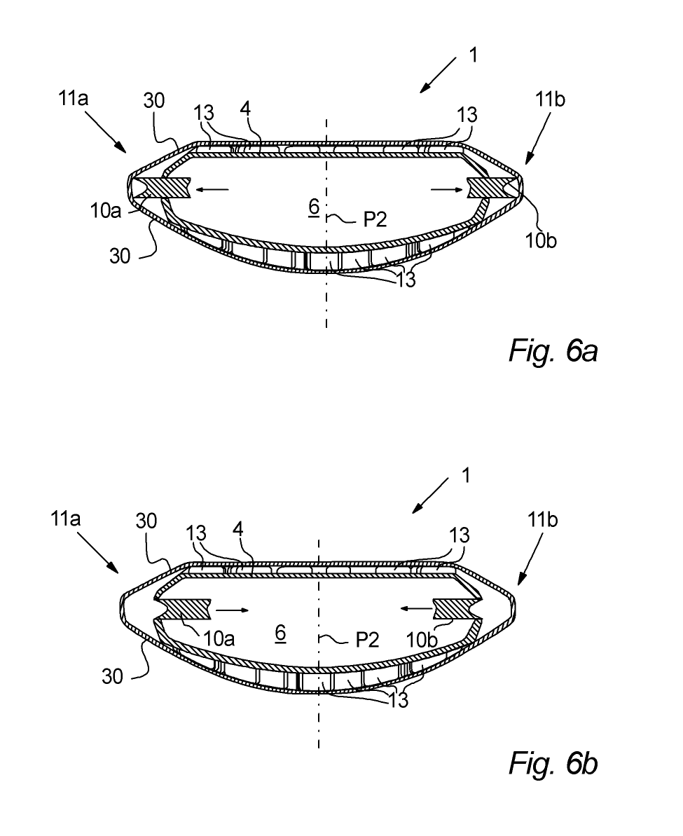

FIG. 6a illustrates a cross sectional view of the pelt board according to embodiments of the invention, where a tubular fur 30 is arranged on the pelt board 1 and the pelt board 1 is in an expanded mode in that the longitudinal parts 10a, 10b are moved away from the plane P2. The tubular fur 30 thus extends around the pelt board while supporting on the protrusions 13 and the longitudinal parts 10a, 10b. Drying air can thus be guided from the internal cavity 6 and in between the tubular fur and the surface of the pelt board 1 by means of ventilation openings (not illustrated in FIG. 6, see e.g. FIGS. 1 and 3), thereby drying the skin side of the fur 30.

FIG. 6b illustrates the pelt board of FIG. 6a in a collapsed position as the longitudinal parts are moved towards the interior cavity 6 o the pelt board towards the centre plane P2. Hereby the circumference of the pelt board is decreased. This provides that the tubular fur 30 can now easily be removed from the pelt board 1, even if the fur 30 was fixed to the pelt board in an expanded mode by a holding bag (e.g. as described in WO 2005/026394 A1), a plastic material wrapped around a holding area at the lower part of the pelt board or the like.

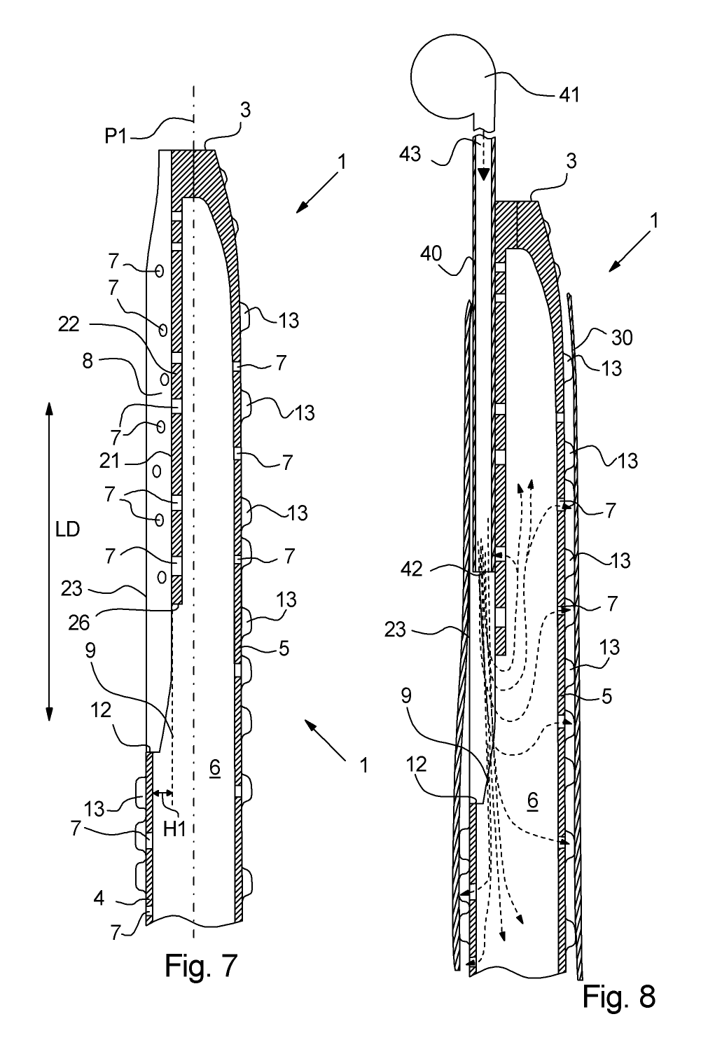

FIGS. 7 and 8 illustrate schematically a cross sectional view of the tapered end 3 of the pelt board 1, at the centre plane P2 (see e.g. FIG. 2) of the pelt board 1 according to embodiments of the invention. It is noted that the number and location of protrusions 13 and ventilation openings 7, and/or the exact shape of the tapered end/tip end may be altered in different ways.

The guiding recess 8 extends from the tapered end/tip end 3 of the pelt board 1 and towards the foot 2 end of the pelt board 1. The guiding recess 8 may in embodiments of the invention comprise one or more ventilation openings 7 in the guiding recess surface 21 for supporting an air exchange part 40.

The internal cavity 6 extends in between the wall 22 providing the guiding recess surface 21 in the half part 4 and the other half part 5. The wall 22 may e.g. be displaced from the first plane P1 as illustrated so that air can be provided between the plane P1 and the lower surface of the wall 22 facing the cavity 6 and/or so that a longitudinal member 10c (see e.g. FIGS. 4 and 5) can extend between the wall 22 and the other half part 5 to displace the half parts 4, 5 away and towards each other (not illustrated) and/or so that longitudinal parts 10a, 10b can be displaced by the longitudinal member away from a centre plane (P2-see e.g. FIG. 2).

The guiding recess 8 is configured to receive an air exchange part 40 for exchanging air in the internal cavity 6 of the pelt board 1 as illustrated in FIG. 8. The tubular pelt 30 is thus arranged on the pelt board 1 by drawing it onto the pelt board 1 from the tip end 3 towards the foot end 2. The air exchange part 40, preferably in the form of a hollow, rigid pipe, is then entered into the recess 8 from the tip end 30 in a free space formed/provided by the recessed surface 21 of the guiding recess 8 and the tubular fur 30 at the tip end 3 of the pelt board 1. The tubular fur 30 supports on upper surfaces 23 of the half part 4 extending at each side of the guiding recess 6. Such upper surfaces 23 may in embodiments of the invention also comprise elevations 13 and/or ventilation openings 7.

The air exchange part comprises an inlet 43 and an outlet 42 for the drying air.

The air exchange part 40 may in embodiments of the invention be a rigid pipe such as a metal pipe or a rigid plastic pipe, but in other embodiments of the invention, the air exchange part may be a flexible hose such as a plastic hose.

The air exchange part 40 thus extends in the longitudinal direction LD of the pelt board 1 and is thus able to blow drying air into the internal cavity 6 through the Drying air supply opening 9.

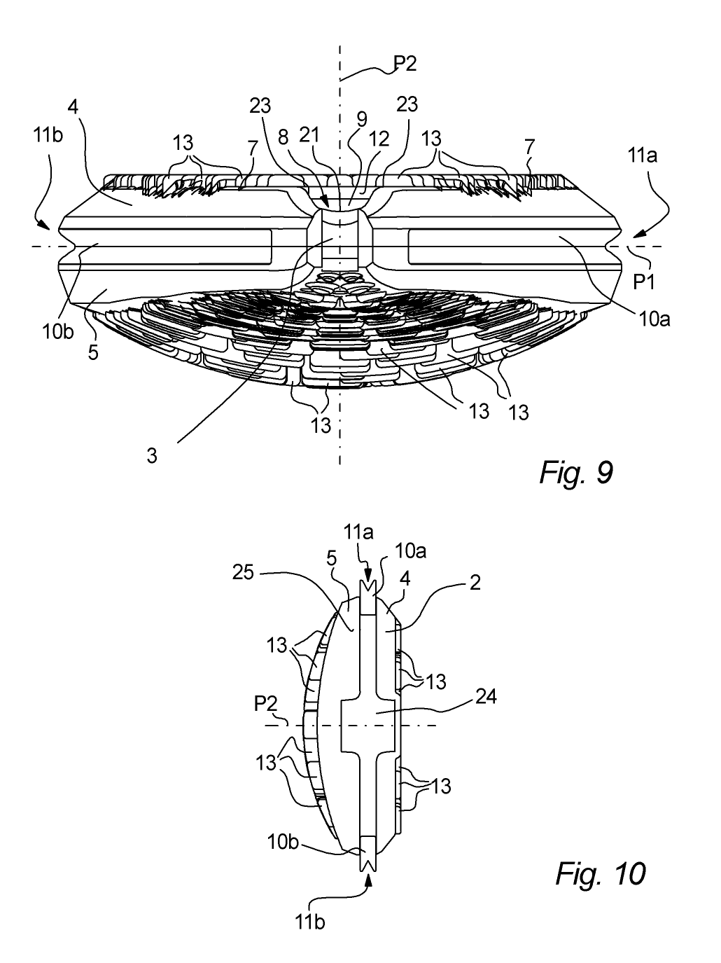

The drying air supply opening 9 extends in embodiments of the invention between the recessed surface 21 of the guiding recess 8 and an upper, elevated edge 12 of the half part 4 comprising the guiding recess 8, see also FIG. 9. The upper elevated edge 12 is thus elevated compared to the recessed surface 21 so that the drying air can enter the cavity 6 between the surface 21 and the upper edge 12 in the longitudinal direction LD of the pelt board. The drying air supply opening 9 thus in preferred embodiments of the invention at least partly extends in a substantially transverse direction compared to the longitudinal direction LD of the pelt board 1, away from a first plane P1 extending through the longitudinal edges 11a, 11b of the pelt board 1, see e.g. FIG. 2.

The drying air supply opening 9 may in embodiments of the invention have a height difference H1 between the upper, elevated edge 12 and the recessed surface 21 between 1.5 mm and 20 mm such as between 2 mm and 10 mm. The height difference H1 may be measured from the lower edge 26 of the opening which may be nearest the tip end 3 if the opening 9 is oblong and extends in the longitudinal direction LD of the pelt board.

The guiding recess 8 ends substantially at the drying air supply opening 9 to the internal cavity 6.

A blowing (or suction) unit 41 can thus be connected to the air exchange part 40 and thus provide a flow of drying air from the exterior of the pelt board 1, through the air exchange part into the cavity 6 where the air is distributed to the ventilation openings 7, or alternatively sucked into the cavity 6 from the ventilation openings.

It is generally to be noted that the pelt board 1 in embodiments of the invention may be configured to receive drying air in the cavity 6 by means of either a drying aggregate for providing drying air at the foot end 2 (e.g. as described previously), or by means of the drying air supply opening at the tip end 3 part of the pelt board 1. A user may thus select where to provide the drying air dependent on the suitable drying system available. In other embodiments of the invention, the pelt board may only be configured for receiving the drying air at the tip end by means of the guiding recess and the drying air supply opening 9.

In preferred embodiments of the invention, the drying air is blown into the cavity 6 by means of a blowing unit 41, e.g. comprising an electrical motor and a fan for being driven by the electrical motor to provide a flow of air into the cavity 6 through the drying air supply opening.

As can be seen in FIGS. 7-8 the internal cavity 6 may extend in between the recessed wall part providing the guiding recess and the opposing half part. The drying air can then after entering the internal cavity 6 at the drying air supply opening 9 move towards the tip end 3 in the internal cavity 6 to dry a part of the skin covering the guiding recess 8 and the tip end part of the half part opposite the guiding recess 6 receiving the air exchange part 40.

FIG. 9 illustrates a pelt board 1 according to the invention seen in perspective from the tapered end 3 of the pelt board 1. The pelt board 1 comprises a substantially flat half part 4 (the upper half part) and an opposite half part 5 (the lower half part) providing a substantially arched outer surface. The longitudinal distension parts 10a, 10b of the distension system are configured to move towards and away from the middle/centre plane P2 of the pelt board between the half parts 4, 5 (which half parts in embodiments of the invention may be fixed in relation to each other) in order to provide a collapsible pelt board 1 as e.g. previously explained. The longitudinal distension parts 10a, 10b extends in the longitudinal direction of the pelt board, substantially the entire length of the pelt board such as at least 70% of the length of the pelt board, e.g. at least 80%, such as at least 90% of the length L1 (see FIG. 1) of the pelt board.

The pelt board 1 may preferably taper towards the tapered end 3 by the edges 11a, 11b tapering towards the centre plane P2. Also, it is preferred that at least one, or both of the broad surfaces comprising the protrusions 13 may taper towards the tapered towards the first plane 1 defined by the edges 11a, 11b.

FIG. 10 illustrates an embodiment of the pelt board 1 seen from the foot end 2, but where the longitudinal member 10c has been removed in order to illustrate that the pelt board comprises a further dying air supply opening 24 to the interior cavity 6. This air supply opening 24 receives an air flow through the channel 20 in the lower part of the longitudinal member 10c. The further dying air supply opening 24 is

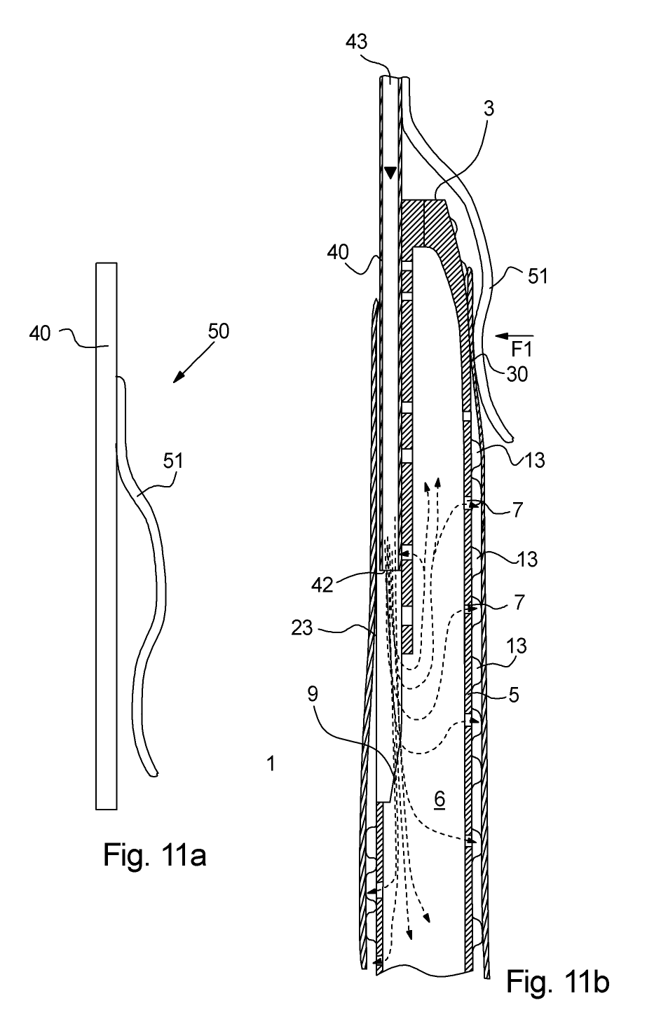

FIGS. 11a and 11b illustrate a drying system. The drying system includes a pelt board 1 according to embodiments of the invention, and a holding device 50. The holding device comprises the air exchange part 40 as previously explained, in the form of an air supply pipe for extending into the guiding recess 8 of the pelt board 1.

Moreover, the holding device 50 comprises a holding arrangement 51, preferably in the form of a clamp or the like. The holding arrangement 51 is configured to provide a holding function when the air exchange part 40 extends into the guiding recess 8.

Preferably, the holding arrangement 51 includes a resiliently arranged clamp for providing a holding force towards the air exchange part 40 when displaced away from the air exchange part 40.

The clamp may thus be arranged at the outside of the pelt 30 when the air exchange part 40 extends into the guiding recess, and thereby provide a holding force F1 so that the pelt board 1 hangs freely from the holding device 50.

Preferably the pelt board is arranged between the holding arrangement 51 and the air exchange part so that the holding arrangement provides the force towards a half part not comprising the guiding recess into which the air exchange part extends.

### LIST

1 Pelt board
1a Cross-sectional outer contour of the pelt board
2 Foot end of pelt board
3 Tapered end/tip end of pelt board
4, 5 Half parts of pelt board
4a, 5a Outer surfaces of broad side surfaces
4b, 5b Outer contour of broad side surfaces
6 Internal cavity for distributing drying air internally in said pelt board
7 Ventilation openings in half parts
8 Guiding recess at tapered end/tip end of pelt board
9 Drying air supply opening at tip end/tapered end part of pelt board
10 Distension system
10a, 10b Longitudinal parts of distension system at longitudinal edges of pelt board
10c Longitudinal member of distension system arranged in the internal cavity of pelt board
11a, 11b Longitudinal edges of pelt board
12 Upper, elevated edge
13 Protrusions at outer surface of half parts for supporting tubular pelt/fur
14a, 15a Hollow at each half part
16, 16a Wedge-shaped elements at longitudinal member of distension system
17 Recesses in longitudinal parts of distension system for receiving wedge shaped elements
18 Opposing surfaces comprising wedge shaped elements.
19 Lower part of longitudinal member extending from foot end of pelt board
20 Channel in longitudinal member for guiding drying air into internal cavity
21 Guiding recess surface
22 Wall providing guiding recess surface
23 Upper surface extending at each side of guiding recess
24 Further drying air supply opening at foot end
25 Lower end surface of the pelt board
26 Lower edge of drying air supply opening
30 Tubular fur on pelt board
40 Air exchange part
41 Air supply unit for generating flow of drying air
42 Outlet of air exchange part
43 Inlet of air exchange part
50 Holding device
51 Holding arrangement of holding device
F1 Holding force
h Height of vertex of convex side surface
H1 Height difference between the upper, elevated edge and recessed surface of guiding recess
LD Longitudinal direction of pelt board
L1 Length of the guiding recess
L2 Length of pelt board
L3 Length of opening
L4 Length of holding area
P1 First plane of pelt board
P2 Second plane of pelt board
W1 Width of linear side surface of pelt board
W2 Width of convex side surface of pelt board

What is claimed is:

1. Pelt board for drying of tubular pelts, the pelt board having a tip end from which the pelt is drawn onto the pelt board and a foot end, the pelt board comprising two broad side surfaces each extending in the longitudinal direction of the pelt board,
wherein at least in a holding area of the pelt board, one of the broad side surfaces is of a substantially linear cross-sectional outer contour, whereas the other of the broad side surfaces is of a substantially convex cross-sectional outer contour,
wherein said holding area is positioned in the half part of the pelt board nearest the foot end thereof and extends at least 25 cm, preferably at least 30 cm in the longitudinal direction of the pelt board.

2. Pelt board according to claim 1, wherein the broad side surface of substantially linear cross-sectional outer contour constitutes at least 20%, preferably at least 25% of the cross-sectional circumference of the pelt board at the holding area.

3. Pelt board according to claim 1, wherein the two broad side surfaces constitute at least 65%, preferably at least 75% of the cross-sectional circumference of the pelt board at the holding area.

4. Pelt board according to claim 1, wherein the height of the vertex of the convex cross-sectional outer contour is in the range of 8 to 25 millimetres from the baseline of the convex outer contour of the broad side surface, preferably in the range of 10 to 20 millimetres.

5. Pelt board according to claim 1 comprising two half parts each defining one of said broad side surfaces.

6. Pelt board according to claim 1, wherein the broad side surfaces within the holding area are provided with a plurality of protrusions.

7. Pelt board according to claim 6, wherein the height of said protrusions are in the range of 0.75 to 5 millimetres, preferably in the range of 1 to 3 millimetres.

8. Pelt board according to claim 1, wherein the cross-sectional circumference of the pelt board at the holding area is in the range of 220 to 240 millimetres.

9. Pelt board according to claim 1, wherein the cross-sectional circumference of the pelt board at the holding area is in the range of 242 to 260 millimetres.

10. Pelt board according to claim 8, the length of which from the tip end to the foot end thereof is in the range of 120 to 160 centimetres, preferably in the range of 125 to 155 centimetres.

11. Pelt board according to claim 1, wherein the cross-sectional circumference of the pelt board at the holding area is in the range of 180 to 200 millimetres.

12. Pelt board according to claim 11, the length of which from the tip end to the foot end thereof is in the range of 100 to 130 centimetres, preferably in the range of 105 to 120 centimetres.

13. Pelt board according to claim 1, wherein the cross-sectional circumference of the pelt board at the holding area is in the range of 380 to 400 millimetres.

14. Pelt board according to claim 13, the length of which from the tip end to the foot end thereof is in the range of 170 to 200 centimetres.

15. Pelt board according to claim 1, comprising expansion means for selectively shifting the pelt board between an expanded position and a non-expanded position in which the outer cross-sectional circumference of the pelt board is reduced as compared to the expanded position.

16. Pelt board according to claim 15, wherein the outer cross-sectional circumference of the pelt board is reduced in the range of 3 to 20 millimetres at least in the holding area when the expansion means are in the non-expanded position of the expansion means, preferably in the range of 5 to 15 millimetres.

17. Pelt board according to claim 1 and comprising an element projecting from the foot end of the pelt board, the projecting element having an inlet for receiving a flow of air and an air conducting arrangement including openings in an outer surface of the pelt board connected to said inlet for providing a flow of air to a pelt arranged on the pelt board.

18. Pelt board according to claim 13, wherein the expansion means may be operated by means of displacing the projecting element in the longitudinal direction of the pelt board.

19. Pelt board according to claim 15, wherein the expansion means may be operated by means of displacing the projecting element in the longitudinal direction of the pelt board.

20. Method of use of a pelt board according to claim 1 for drying of tubular pelts, wherein the back side of the pelt is arranged at the broad side surface of convex outer contour, and the belly side of the pelt is arranged at the broad side surface of the linear outer contour.

21. Method of use according to claim 20, wherein the pelt is stretched in a longitudinal direction of the pelt board towards the foot end of the pelt board and fixing means are applied to the fur side of the pelt at a position of the holding area so as to fix the pelt to the pelt board.

22. Method of use according to claim 20, wherein said pelts are mink pelts, in particular male mink pelts.

23. Pelt board according to claim 9, the length of which from the tip end to the foot end thereof is in the range of 120 to 160 centimetres, preferably in the range of 125 to 155 centimetres.
